(19) United States
(12) Patent Application Publication
(10) Pub. No.: US 2026/0249262 A1
(43) Pub. Date: Aug. 27, 2026

(54) AMMONIA DECOMPOSITION REACTOR HAVING FUNCTION OF PREHEATING AMMONIA GAS

(71) Applicants: FUZHOU UNIVERSITY, Fuzhou, Fujian Province (CN); FZU ZIJIN HYDROGEN POWER TECHNOLOGY CO., LTD, Fuzhou City, Fujian Province (CN)

(72) Inventors: Lilong JIANG, Fuzhou (CN); Dabiao WANG, Fuzhou (CN); Yu LUO, Fuzhou (CN); Qing ZHANG, Fuzhou City (CN); Chongqi CHEN, Fuzhou (CN); Li LIN, Fuzhou (CN)

(73) Assignees: FUZHOU UNIVERSITY, Fuzhou, Fujian Province (CN); FZU ZIJIN HYDROGEN POWER TECHNOLOGY CO., LTD, Fuzhou City, Fujian Province (CN)

(21) Appl. No.: 18/874,685

(22) PCT Filed: Jun. 18, 2023
(86) PCT No.: PCT/CN2023/100916

§ 371 Date: Dec. 13, 2024

(30) Foreign Application Priority Data
Jun. 21, 2022 (CN) 202210707426.5

(51) Int. Cl. B01J 19/00; B01J 19/24

(52) U.S. Cl. CPC B01J 19/0013; B01J 19/24; B01J 2219/00096

(57) ABSTRACT

An ammonia decomposition reactor having a function of preheating ammonia gas, including a heat exchanger body and a reactor body enveloped externally by the heat exchanger body. A heat-exchange tube on the heat exchanger body is provided in a heat-exchange shell, one end is in communication with an ammonia gas heat-exchange inlet, and the other end is in communication with an ammonia gas heat-exchange outlet. A heat medium inlet and A heat medium outlet are individually connected to the heat-exchange shell. A catalyst tube is provided in a reaction shell. An ammonia gas heat-exchange outlet on the heat exchanger body is in communicated with an ammonia gas inlet on the reactor body, an ammonia gas inlet is communicated with an ammonia-gas-decomposition-gas outlet by a catalyst tube, and the ammonia-gas-decomposition-gas outlet is communicated with a heat medium inlet on the heat exchanger body.

### CROSS REFERENCE TO RELATED APPLICATION

This patent application is a national stage application of International Patent Application PCT/CN2023/100916 filed on Jun. 18, 2023 which claims the benefit and priority of Chinese Patent Application No. 202210707426.5 filed with the China National Intellectual Property Administration on Jun. 21, 2022, the disclosure of which is incorporated by reference herein in its entirety as part of the present application.

### TECHNICAL FIELD

The disclosure relates to the technical field of reactors, and specifically relates to an ammonia decomposition reactor having a function of preheating ammonia gas.

### BACKGROUND

Reactors are equipment to realize reaction processes, which are widely used in chemical industry, oil refining, metallurgy and other fields. The reactors can be used to realize liquid-phase single-phase reaction processes and multi-phase reaction processes such as liquid-liquid, gas-liquid, liquid-solid, gas-liquid-solid reaction processes. In the ammonia-hydrogen fuel cell system, as important equipment for ammonia decomposition, the reactors often involve a fact that the degree of ammonia gas decomposition is not high due to insufficient heat supply during reaction processes. Therefore, if the ammonia gas can be preheated, the degree of ammonia gas decomposition can be significantly improved. At the present stage, the way to preheat ammonia gas is to add an independent heat exchanger in the system. The heat exchanger has a large volume, and thus is not conducive to the integration of the ammonia-hydrogen fuel cell system.

### SUMMARY

To address the issues in related art including low degrees of ammonia gas decomposition reactions in ammonia decomposition reactors, large structures of the preheating heat exchangers, and influences on an overall system integration, the disclosure provides an ammonia decomposition reactor having a function of preheating ammonia gas.

The disclosure adopts technical solutions as follows:

An ammonia decomposition reactor having a function of preheating ammonia gas, including a heat exchanger body and a reactor body enveloped externally by the heat exchanger body;
wherein the heat exchanger body includes a heat-exchange shell, a heat-exchange tube, an ammonia gas heat-exchange inlet, an ammonia gas heat-exchange outlet, a heat medium inlet and a heat medium outlet, wherein the heat-exchange tube is provided in the heat-exchange shell, one end thereof is in communication with the ammonia gas heat-exchange inlet, and the other end thereof is in communication with the ammonia gas heat-exchange outlet, and the heat medium inlet and the heat medium outlet are individually connected to the heat-exchange shell;
wherein the reactor body includes a reaction shell, a catalyst tube, an ammonia gas inlet, and an ammonia-gas-decomposition-gas outlet, wherein the catalyst tube is provided in the reaction shell, the ammonia gas heat-exchange outlet is in communication with the ammonia gas inlet, the ammonia gas inlet is in communication with the ammonia-gas-decomposition-gas outlet by the catalyst tube, and the ammonia-gas-decomposition-gas outlet is in communication with the heat medium inlet.

In an embodiment, the heat exchanger body is an annular structure formed of two identical sectored semi-circular heat exchangers combined together, the ammonia gas heat-exchange inlet is divided through pipeline, and then is individually in communication with the heat-exchange tubes in the sectored semi-circular heat exchangers at both sides, and the ammonia gas heat-exchange outlets on the sectored semi-circular heat exchangers at both sides are converged through pipeline and then connected to the ammonia gas inlet.

A plurality of heat-exchange tubes are provided in the heat exchanger body, and the heat-exchange tubes are uniformly arranged in the heat exchanger body in a circumferential direction thereof.

Both ends of the heat-exchange shell are provided with heat-exchange tube plates, the heat-exchange tube plates each are arranged with opening holes uniformly along a circumferential direction thereof, and two ends of the heat-exchange tubes are respectively in communication with the ammonia gas heat-exchange inlet and the ammonia gas heat-exchange outlet through the opening holes on the heat-exchange tube plates.

The ammonia-gas-decomposition-gas outlet is connected to the heat medium inlet through pipeline, and then is divided and connected to the heat-exchange shells at both sides.

In an embodiment, the reactor body is therein arranged with a plurality of catalyst tubes, and each catalyst tube is therein filled with catalyst for ammonia decomposition reaction.

In an embodiment, both ends of the reaction shell are arranged with catalyst tube plates, four openings are uniformly arranged on each catalyst tube plate in a circumferential direction thereof, and four catalyst tubes are arranged in the reaction shell, and both ends of the catalyst tubes are respectively penetrated and fixedly provided through the openings on the catalyst tube plates.

The reaction shell is on a side wall of one end thereof arranged with a hot source gas inlet connected to the reaction shell, and on an opposite side of an other end thereof is arranged with a hot source gas outlet, and both the hot source gas inlet and the hot source gas outlet are extended beyond the heat-exchange shell through connection pipelines.

The hot source gas inlet has a larger pipe diameter than that of the hot source gas outlet.

The catalyst tube is at both ends thereof individually arranged with a screen for preventing the catalyst from leaking, and the screen has a mesh size of 80 meshes to 120 meshes.

The technical solutions according to this disclosure have advantages as follows:
a) The ammonia decomposition reactor having a function of preheating ammonia gas according to this disclosure has a compact structure. The high-temperature gas of the ammonia-gas-decomposition-gas in the reactor is employed as heat medium of the heat exchanger to provide heat for preheating ammonia gas, so that ammonia gas entering the reactor is in a high-temperature state, making the ammonia decomposition reaction carried out in the reactor to be more sufficient.
b) The reactor of the present disclosure differs from the existing equipment in that the reactor incorporating the heat exchanger is more compact in structure and more reasonable in space utilization. An outer shell of the reactor is enveloped by the heat exchanger, the reactor can also provide heat source for the heat exchanger, and the heat exchanger itself can be used as a thermal insulating layer for the reactor, which effectively ensures temperature conditions inside the reactor, and avoids heat loss of the system as well as a problem of reaction process being insufficient.

### BRIEF DESCRIPTION OF THE DRAWINGS

In order to more clearly illustrate the embodiments of this disclosure, accompanying drawings used in the embodiments will be briefly introduced below. Apparently, the accompanying drawings in the following description are merely some embodiments of this disclosure, and for the person skilled in the art, other drawings can be obtained based on these accompanying drawings without creative efforts.

FIG. 1 shows a schematic structural diagram of an ammonia decomposition reactor having a function of preheating ammonia gas according to an embodiment of the disclosure.

FIG. 2 shows a schematic structural diagram of a heat exchanger body according to an embodiment of the disclosure.

FIG. 3 shows a schematic structural diagram of an internal heat exchange pipe and an external connection pipe of a heat exchanger body according to an embodiment of the disclosure.

FIG. 4 shows a schematic structural diagram of a reactor body according to an embodiment of the disclosure.

### REFERENCE NUMERALS

1: heat exchanger body; 11: heat-exchange shell; 111: heat-exchange tube plate; 12: heat-exchange tube; 13: ammonia gas heat-exchange inlet; 14: ammonia gas heat-exchange outlet; 15: heat medium inlet; 16: heat medium outlet; 17: product-merging exit; 18: elbow tube; 2: reactor body; 21: reaction shell; 211: catalyst tube plate; 22: catalyst tube; 23: ammonia gas inlet; 24 ammonia-gas-decomposition-gas outlet; 25: hot source gas inlet; 26: hot source gas outlet; 27: screen; 3: catalyst.

### DETAILED DESCRIPTION OF THE EMBODIMENTS

Technical solutions of the disclosure will be described clearly and thoroughly in conjunction with the accompanying drawings below. Apparently, the described embodiments are parts of, not all of the embodiments of the disclosure. Based on the embodiments of the disclosure, all other embodiments obtained by the person skilled in the art without creative efforts fall within the scope of the disclosure.

As shown in FIG. 1, this disclosure provides an ammonia decomposition reactor having a function of preheating ammonia gas, including a heat exchanger body 1 and a reactor body 2 enveloped externally by the heat exchanger body 1. The heat exchanger body 1 includes a heat-exchange shell 11, heat-exchange tubes 12, an ammonia gas heat-exchange inlet 13, an ammonia gas heat-exchange outlet 14, a heat medium inlet 15, and a heat medium outlet 16, wherein each heat-exchange tube 12 is arranged in the heat-exchange shell 11, one end thereof is in communication with the ammonia gas heat-exchange inlet 13, and the other end thereof is in communication with the ammonia gas heat-exchange outlet 14, and the heat medium inlet 15 and the heat medium outlet 16 are individually connected to the heat-exchange shell 11. The reactor body 2 includes a reaction shell 21, a catalyst tube 22, an ammonia gas inlet 23, and an ammonia-gas-decomposition-gas outlet 24, wherein the catalyst tube 22 is arranged in the reaction shell 21, the ammonia gas heat-exchange outlet 14 is in communication with the ammonia gas inlet 23, the ammonia gas inlet 23 is in communication with the ammonia-gas-decomposition-gas outlet 24 by the catalyst tube 22, and the ammonia-gas-decomposition-gas outlet 24 is in communication with the heat medium inlet 15. In an embodiment of the disclosure, ammonia gas is input from the ammonia gas heat-exchange inlet 13, and is travelled through a tube pass of a heat exchanger, and after heat exchange in the heat exchanger, is travelled from the ammonia gas heat-exchange outlet 14 to the ammonia gas inlet 23 of the reactor. The heat medium inlet 15 of the heat exchanger is connected to the ammonia-gas-decomposition-gas outlet 24, and high-temperature ammonia-gas-decomposition-gas (hydrogen and nitrogen gases) is input into a shell pass of the heat exchanger via the heat medium inlet 15 of the heat exchanger to provide heat for the ammonia gas in the tube pass, so as to perform a heat exchange. By using the high-temperature ammonia-gas-decomposition-gas as heat source of the heat exchanger, a heat exchange rate of the overall system is improved, a heat loss of the system is reduced, and the ammonia gas preheated by the heat exchanger enters the reactor for ammonia decomposition reaction to realize a relatively high reaction degree.

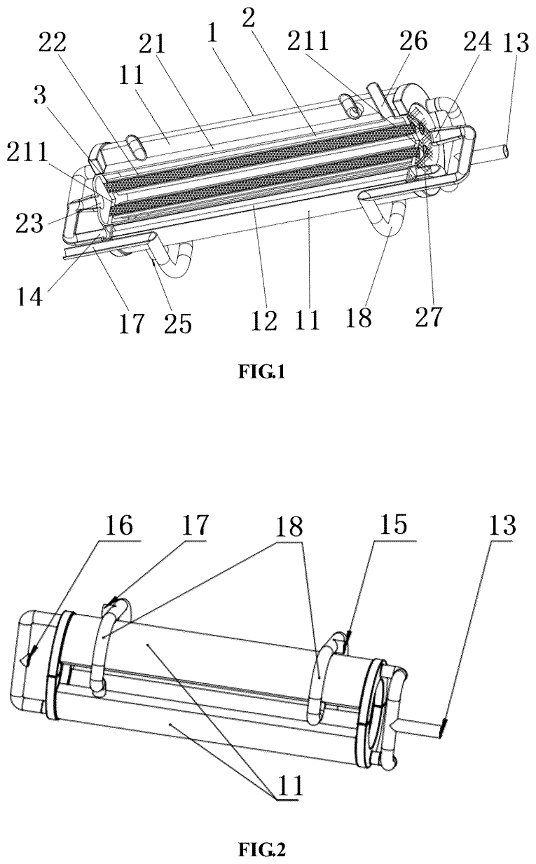

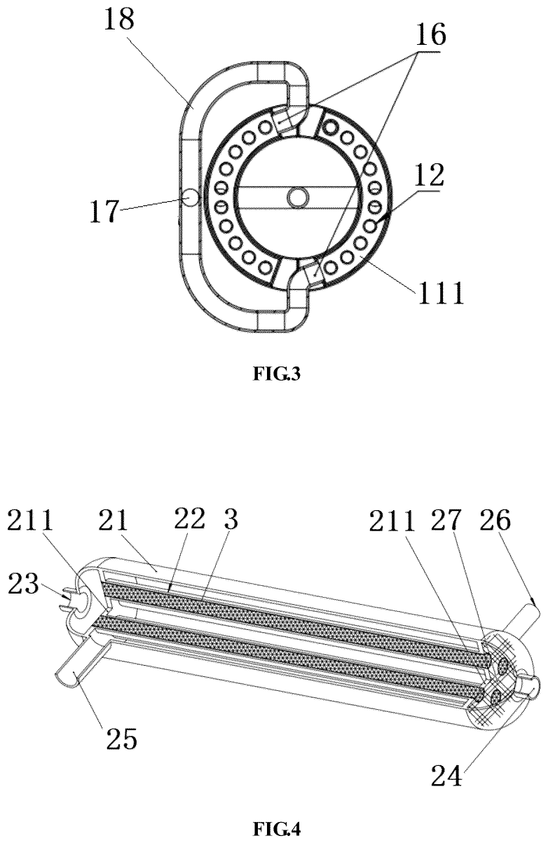

Further, as shown in FIG. 2 and FIG. 3, the heat exchanger body 1 is an annular structure formed of two identical sectored semi-circular heat exchangers combined together, the ammonia gas heat-exchange inlet 13 is divided through pipeline, and then is individually communicated with the heat-exchange tubes 12 in the sectored semi-circular heat exchangers at both sides. The ammonia gas heat-exchange outlets 14 on the sectored semi-circular heat exchangers at both sides are converged through pipeline and then connected to the ammonia gas inlet 23. A plurality of heat-exchange tubes 12 are provided in the heat exchanger body 1, and the heat-exchange tubes 12 are uniformly arranged in the heat exchanger body 1 along a circumferential direction thereof. Both ends of the heat-exchange shell 11 are provided with heat-exchange tube plates 111, each of the heat-exchange tube plates 111 is uniformly provided with opening holes along its circumferential direction, and two ends of the heat-exchange tubes 12 are respectively communicated with the ammonia gas heat-exchange inlet 13 and the ammonia gas heat-exchange outlet 14 through the opening holes on the heat-exchange tube plates 111. The ammonia-gas-decomposition-gas outlet 24 is connected to the heat medium inlet 15 through pipeline, and then is divided and connected to the heat-exchange shells 11 at both sides. The heat medium outlets 16 on outsides of the both heat-exchange shells 11 are joined together through elbow tubes 18 and are merged into a product-merging exit 17. The ammonia gas is input from the ammonia gas heat-exchange inlet 13, and then is divided through pipeline to individually enter the heat-exchange tubes 12 in the heat exchanger at both sides, and then is collected through pipeline on the other side of the heat exchanger to reach the ammonia gas heat-exchange outlet 14. The high-temperature ammonia-gas-decomposition-gas after travelling through the reactor is input via the heat medium inlet 15 of the heat exchanger, and is individually flowed into the heat-exchange shells 11 of the heat exchanger at both sides through pipeline, so as to exchange heat with the low-temperature ammonia gas in the heat-exchange tubes 12. The high-temperature ammonia-gas-decomposition-gas after having exchanged heat in the two sides of the heat exchanger is collected along the heat medium outlets 16 of the heat exchanger at both sides through the elbow tube 18, and reaches the product-merging exit 17 of the heat exchanger.

As shown in FIG. 4, both ends of the reaction shell 21 are arranged with catalyst tube plates 211, four openings are uniformly arranged on each catalyst tube plate 211 in a circumferential direction thereof. Four catalyst tubes 22 are arranged in the reaction shell 21, and both ends of each catalyst tube 22 are respectively penetrated and fixedly provided through the openings on the catalyst tube plates 211. The catalyst tubes 22 are therein filled with catalyst 3 for ammonia decomposition reaction. The reaction shell 21 is on a side wall of one end thereof arranged with a hot source gas inlet 25 connected to the reaction shell 21, and on an obliquely opposite side of the other end thereof is arranged with a hot source gas outlet 26. Both the hot source gas inlet 25 and the hot source gas outlet 26 are extended beyond the heat-exchange shell 11 through connection pipelines. The hot source gas inlet 25 has a larger pipe diameter than that of the hot source gas outlet 26, so as to increase retention time of hot source gas in the reaction shell 21 and provide more heat for the ammonia decomposition reaction. Each catalyst tube 22 is at both ends thereof arranged with a screen 27 individually, to prevent the catalyst 3 in the catalyst tube 22 from leaking, and the screen 27 has a mesh size of 80 meshes to 120 meshes.

In addition, the hot source gas outlet 26 can also be communicated with the heat medium inlet 15 for providing heat to the heat exchanger, so that the heat of the hot source gas introduced from the hot source gas inlet 25 is fully utilized.

This disclosure differs from the existing equipment in that the reactor incorporating the heat exchanger is more compact in structure and more reasonable in space utilization. An outer shell of the reactor is enveloped by the heat exchanger, and the reactor can also provide heat source for the heat exchanger, and the heat exchanger itself can be used as a thermal insulating layer for the reactor, which effectively ensures temperature conditions inside the reactor, and avoids heat loss of the system as well as a problem of reaction process being insufficient.

What is not described herein in this disclosure is appliable to the prior art.

Obviously, the above embodiments are merely examples for the purpose of clear illustration, and are not intended to limit the embodiments. For the person skilled in the art, other variations or changes in different forms can be made on the basis of the above description. It is neither necessary nor possible to exhaust all the embodiments herein. The obvious variations or changes derived therefrom still fall within the scope of the present disclosure.

What is claimed is:

1. An ammonia decomposition reactor having a function of preheating ammonia gas, comprising a heat exchanger body (1) and a reactor body (2) enveloped externally by the heat exchanger body (1);
wherein the heat exchanger body (1) comprises a heat-exchange shell (11), a heat-exchange tube (12), an ammonia gas heat-exchange inlet (13), an ammonia gas heat-exchange outlet (14), a heat medium inlet (15) and a heat medium outlet (16), wherein the heat-exchange tube (12) is provided in the heat-exchange shell (11), one end thereof is in communication with the ammonia gas heat-exchange inlet (13), and an other end thereof is in communication with the ammonia gas heat-exchange outlet (14), and the heat medium inlet (15) and the heat medium outlet (16) are individually connected to the heat-exchange shell;
the reactor body (2) comprises a reaction shell (21), a catalyst tube (22), an ammonia gas inlet (23), and an ammonia-gas-decomposition-gas outlet (24), wherein the catalyst tube (22) is provided in the reaction shell (21), the ammonia gas heat-exchange outlet (14) is in communication with the ammonia gas inlet (23), the ammonia gas inlet (23) is in communication with the ammonia-gas-decomposition-gas outlet (24) by the catalyst tube (22), and the ammonia-gas-decomposition-gas outlet (24) is in communication with the heat medium inlet (15).

2. The ammonia decomposition reactor having the function of preheating ammonia gas in accordance with claim 1, wherein the heat exchanger body (1) is an annular structure formed of two identical sectored semi-circular heat exchangers combined together, the ammonia gas heat-exchange inlet (13) is divided through pipeline, and then is individually in communication with the heat-exchange tubes (12) in the sectored semi-circular heat exchangers at both sides, and the ammonia gas heat-exchange outlets (14) on the sectored semi-circular heat exchangers at both sides are converged through pipeline and then connected to the ammonia gas inlet (23).

3. The ammonia decomposition reactor having the function of preheating ammonia gas in accordance with claim 2, wherein a plurality of heat-exchange tubes (12) are provided in the heat exchanger body (1), and the heat-exchange tubes (12) are uniformly arranged in the heat exchanger body (1) in a circumferential direction thereof.

4. The ammonia decomposition reactor having the function of preheating ammonia gas in accordance with claim 3, wherein both ends of the heat-exchange shell (11) are provided with heat-exchange tube plates (111), the heat-exchange tube plates (111) are arranged with opening holes uniformly along a circumferential direction thereof, and two ends of the heat-exchange tubes (12) are respectively in communication with the ammonia gas heat-exchange inlet (13) and the ammonia gas heat-exchange outlet (14) through the opening holes on the heat-exchange tube plates (111).

5. The ammonia decomposition reactor having the function of preheating ammonia gas in accordance with claim 4, wherein the ammonia-gas-decomposition-gas outlet (24) is connected to the heat medium inlet (15) through pipeline, and then is divided and connected to the heat-exchange shells (11) at both sides.

6. The ammonia decomposition reactor having the function of preheating ammonia gas in accordance with claim 5, wherein the reactor body (2) is therein arranged with a plurality of catalyst tubes (22), and the catalyst tubes (22) are therein filled with catalyst for ammonia decomposition reaction.

7. The ammonia decomposition reactor having the function of preheating ammonia gas in accordance with claim 6, wherein both ends of the reaction shell (21) are arranged with catalyst tube plates (211), four openings are uniformly arranged on each catalyst tube plate (211) in a circumferential direction thereof, and four catalyst tubes (22) are arranged in the reaction shell (21), and both ends of the catalyst tubes (22) are respectively penetrated and fixedly provided through the openings on the catalyst tube plates (211).

8. The ammonia decomposition reactor having the function of preheating ammonia gas in accordance with claim 7, wherein the reaction shell (21) is on a side wall of one end thereof arranged with a hot source gas inlet (25) connected to the reaction shell (21), and on an opposite side of an other end thereof is arranged with a hot source gas outlet (26), and both the hot source gas inlet (25) and the hot source gas outlet (26) are extended beyond the heat-exchange shell (11) through connection pipelines.

9. The ammonia decomposition reactor having the function of preheating ammonia gas in accordance with claim 8, wherein the hot source gas inlet (25) has a larger pipe diameter than that of the hot source gas outlet (26).

10. The ammonia decomposition reactor having the function of preheating ammonia gas in accordance with claim 9, wherein the catalyst tube (22) is at both ends thereof individually arranged with a screen (27) for preventing the catalyst (3) from leaking, and the screen (27) has a mesh size of 80 meshes to 120 meshes.
